(19) United States
(12) Patent Application Publication
(10) Pub. No.: US 2025/0027588 A1
(43) Pub. Date: Jan. 23, 2025

(54) CORRUGATED PIPE MOUNTING ASSEMBLY

(71) Applicant: NEW WIDETECH INDUSTRIES CO., LTD., NEW TAIPEI CITY (TW)

(72) Inventor: MING-TSUNG CHIU, NEW TAIPEI CITY (TW)

(21) Appl. No.: 18/353,194

(22) Filed: Jul. 17, 2023

(51) Int. Cl. F16L 25/00; F24F 13/02

(52) U.S. Cl. CPC F16L 25/0045; F24F 13/0209

(57) ABSTRACT

A corrugated pipe mounting assembly has a corrugated pipe and a connector. The corrugated pipe has multiple protruding stripes and multiple gaps each formed between adjacent two of the multiple protruding stripes. The connector has a connecting mount, an operating element, and two engaging components. The operating element has a pivot end pivotally connected to the connecting mount and an operating end being opposite to the pivot end. The two engaging components respectively protrude from the connecting mount and the operating element and each have multiple engaging stripes. When the operating element pivots, the operating end is connected to the connecting mount such that the operating element and the connecting mount are sheathed onto an end of the corrugated pipe and each engaging stripe is inserted into a respective gap of the corrugated pipe. Thereby, the corrugated pipe can be stably mounted via the connector only.

### BACKGROUND OF THE INVENTION

### 1. Field of the Invention

The present invention relates to a corrugated pipe, and particularly to a corrugated pipe mounting assembly.

### 2. Description of Related Art

A movable air conditioner is a kind of air conditioner that has casters for adjusting its position indoors, and the movable air conditioner is connected to hoses for discharging waste heat outdoors. With reference to FIG. 7, a movable air conditioner 90 is connected to a window kit 81 mounted on a window W via a corrugated pipe 91. With reference to FIGS. 7 and 8, the corrugated pipe 91 is connected to the window kit 81 by a connecting nozzle 82 and a connecting sleeve 83; specifically, the connecting sleeve 83 has a sheathing groove 831 for an outlet end 911 of the corrugated pipe 91 to be inserted into, and the connecting nozzle 82 is mounted at an opening 811 of the window kit 81 and has multiple flexible fasteners 821. By operating the multiple flexible fasteners 821, the multiple flexible fasteners 821 can be engaged with or disengaged from an annular rib 832 on the connecting sleeve 83, which allows the corrugated pipe 91 to be mounted to or be detached from the window kit 81.

Although the corrugated pipe 91 applied on the movable air conditioner 90 mentioned above can be assembled or disassembled by the connecting nozzle 82 and the connecting sleeve 83, multiple connecting actions between the corrugated pipe 91, the connecting sleeve 83, and the connecting nozzle 82 are needed during assembling. Otherwise, operating the multiple flexible fasteners 821 to be engaged with the annular rib 832 of the connecting sleeve 83 needs more force and strength. In general, the above-mentioned configurations make assembling and disassembling of the corrugated pipe 91 more cumbersome.

To overcome the shortcomings of the conventional assembling configurations for the corrugated pipe, the present invention tends to provide a corrugated pipe mounting assembly to mitigate or obviate the aforementioned problems.

### SUMMARY OF THE INVENTION

The main objective of the present invention is to provide a corrugated pipe mounting assembly that makes operations of assembling and disassembling easier and maintains sufficient assembling stability.

The corrugated pipe mounting assembly has a corrugated pipe and a connector. The corrugated pipe has multiple protruding stripes and multiple gaps; the multiple protruding stripes are located on a periphery of the corrugated pipe and arranged at spaced intervals, and each one of the multiple gaps is formed between adjacent two of the multiple protruding stripes. The connector has a connecting mount, an operating element, and two engaging components. The operating element has a pivot end pivotally connected to the connecting mount and an operating end being opposite to the pivot end. The two engaging components are respectively disposed on the connecting mount and the operating element, and each one of the two engaging components has multiple engaging stripes protruding from the connecting mount or the operating element and arranged at spaced intervals. The operating element is configured to pivot relative to the connecting mount such that the operating end is connected to the connecting mount, the operating element and the connecting mount are sheathed onto one of two opposite ends of the corrugated pipe, and each one of the multiple engaging stripes is inserted into a respective one of the multiple gaps of the corrugated pipe.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a corrugated pipe mounting assembly of a preferred embodiment in accordance with the present invention applied on a movable air conditioner;

FIG. 2 is a partial exploded view of the corrugated pipe mounting assembly in FIG. 1;

FIG. 3 is an operational view of the corrugated pipe mounting assembly in FIG. 1;

FIG. 4 is an enlarged partial sectional bottom side view of the corrugated pipe mounting assembly in FIG. 1;

FIG. 5 is an enlarged view of FIG. 4;

FIG. 6 is another partial exploded view of the corrugated pipe mounting assembly in FIG. 1;

FIG. 7 is a perspective view of conventional configurations of a pipeline of a movable air conditioner in accordance with the prior arts; and

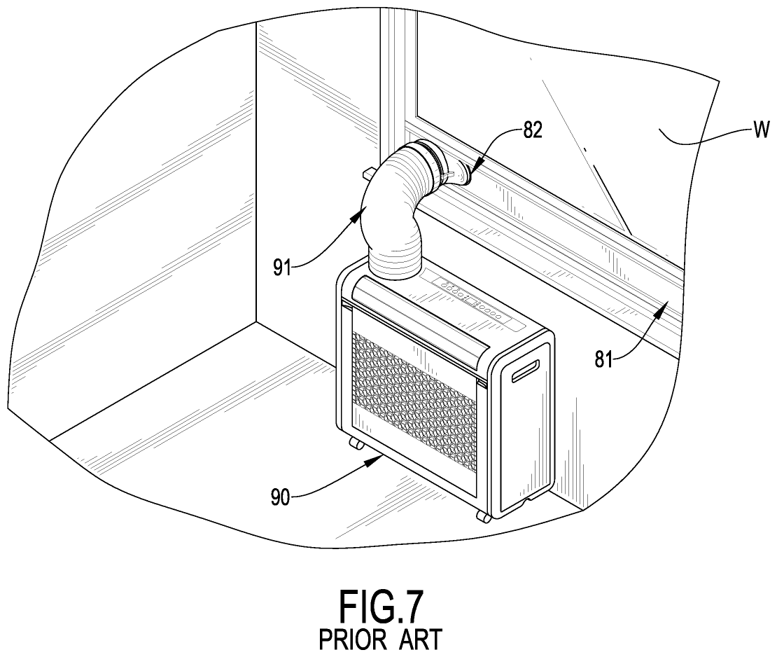

FIG. 8 is a partial sectional side view of FIG. 7.

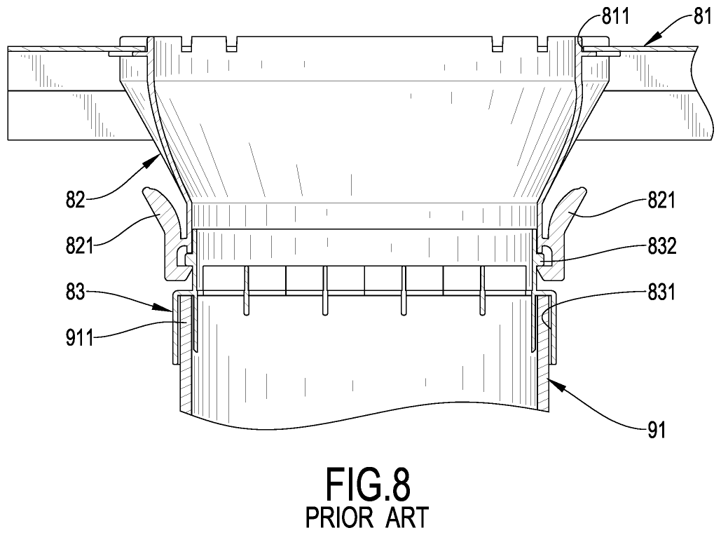

### DETAILED DESCRIPTION OF THE PREFERRED EMBODIMENT

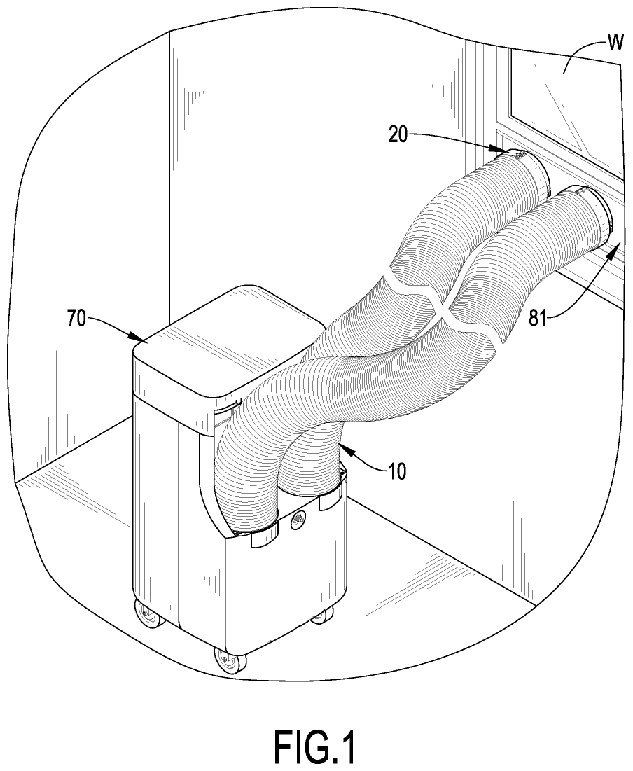

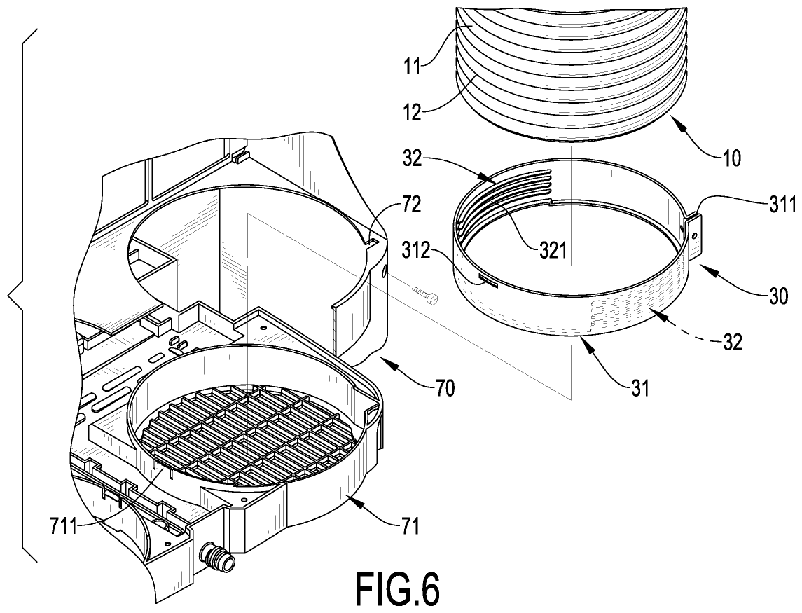

With reference to FIGS. 1, 2, and 6, a corrugated pipe mounting assembly of a preferred embodiment in accordance with the present invention has a corrugated pipe 10, a connector 20, and an assembly adaptor 30. With reference to FIG. 1, when the corrugated pipe mounting assembly is applied for a movable air conditioner 70 to fluidly communicate with the outdoors, the connector 20 is configured to mount one of two opposite ends (defined as an outlet end) of the corrugated pipe 10 to a window kit 81 disposed on a window W; with reference to FIG. 6, the assembly adaptor 30 is configured to mount the other one of the two opposite ends (defined as an inlet end) of the corrugated pipe 10 to the movable air conditioner 70.

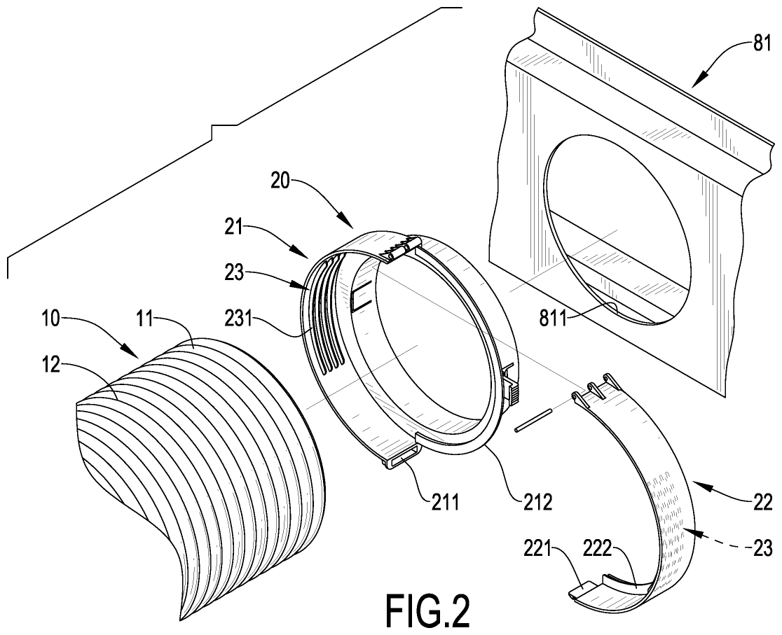

With reference to FIGS. 2, 4, and 6, the corrugated pipe 10 has multiple protruding stripes 11 located on a periphery of the corrugated pipe 10, arranged at spaced intervals, and forming a thread-like appearance; the corrugated pipe 10 has multiple gaps 12, and each one of the multiple gaps 12 is formed between adjacent two of the multiple protruding stripes 11. The corrugated pipe 10 is a stretchable and bendable hose.

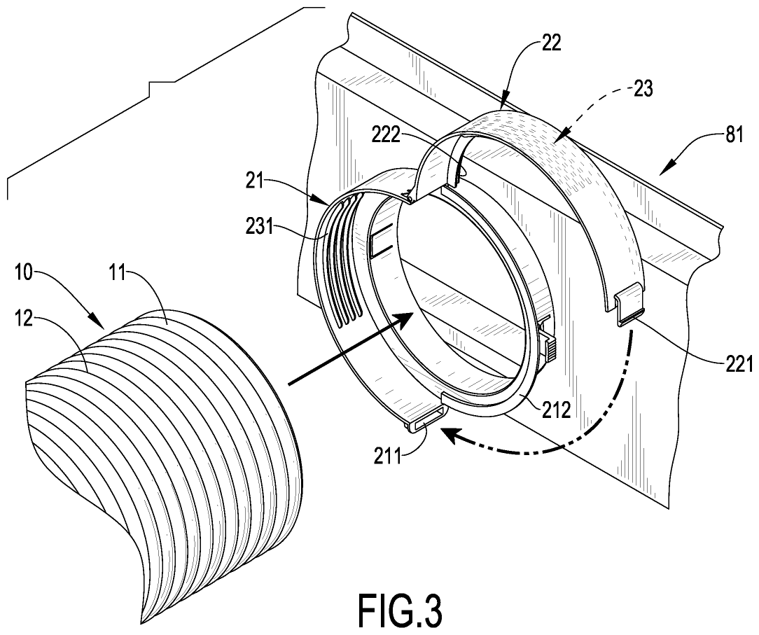

With reference to FIGS. 2 and 3, the connector 20 has a connecting mount 21, an operating element 22, and two engaging components 23, and the operating element 22 is pivotally connected to the connecting mount 21. Specifically, each one of the connecting mount 21 and the operating element 22 has an arc-shaped construction, and the operating element 22 has a pivot end and an operating end being opposite to each other. The pivot end of the operating element 22 is pivotally connected to one of two opposite ends of the connecting mount 21, and the operating end of the operating element 22 is configured to approach and be connected to or move away from the other one of the two opposite ends of the connecting mount 21 as the operating element 22 pivots such that the connector 20 is closed and becomes annular in shape or is unfolded.

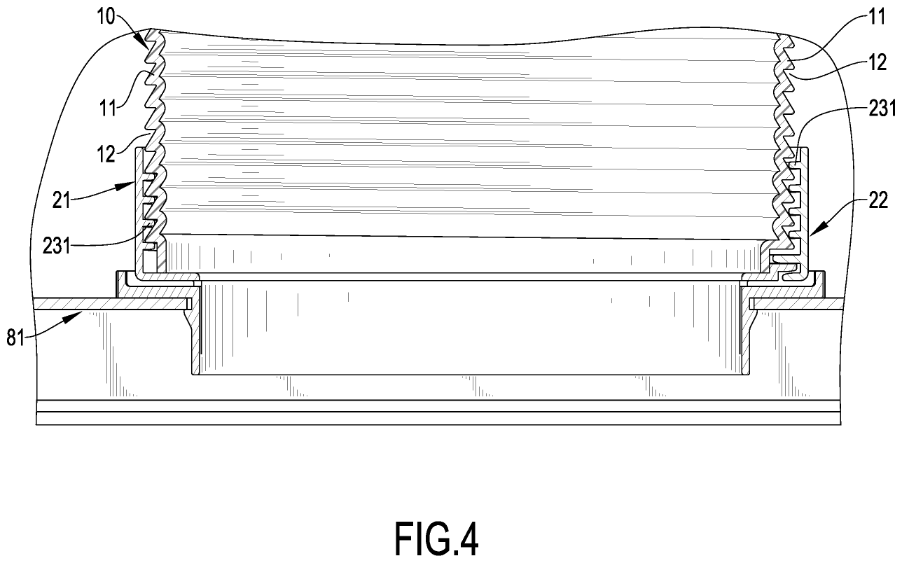

With reference to FIGS. 2 and 3, the two engaging components 23 are respectively disposed on the connecting mount 21 and the operating element 22, and specifically on an inside surface of the connecting mount 21 and an inside surface of the operating element 22. Each one of the two engaging components 23 has multiple engaging stripes 231 arranged at spaced intervals and extending along a same direction; each one of the multiple engaging stripes 231 protrudes from a respective one of the connecting mount 21 and the operating element 22 and extends to be arc-shaped. With reference to FIGS. 3 and 4, the operating element 22 is configured to pivot relative to the connecting mount 21 so as to make the operating element 22 and the connecting mount 21 together sheathed onto the outlet end of the corrugated pipe 10 and make each one of the multiple engaging stripes 231 inserted into a respective one of the multiple gaps 12 of the corrugated pipe 10. With reference to FIG. 4, at the time, the two engaging components 23 face each other.

With reference to FIGS. 3 and 4, in use, the connector 20 is first mounted to an opening 811 of the above-mentioned window kit 81 and is in an unfolded condition. Next, the outlet end of the corrugated pipe 10 is dragged to the connecting mount 21 of the connector 20, and each one of the multiple engaging stripes 231 of said engaging component 23 on the connecting mount 21 is inserted into the corresponding gap 12 of the corrugated pipe 10. Afterwards, the operating element 22 is actuated to pivot relative to the connecting mount 21 such that the operating end of the operating element 22 is connected to the connecting mount 21; at the time, the operating element 22 and the connecting mount 21 are sheathed onto the outlet end of the corrugated pipe 10, and each one of the multiple engaging stripes 231 of said engaging component 23 on the operating element 22 is inserted into the corresponding gap 12 of the corrugated pipe 10. Assembling of the corrugated pipe 10 onto the window kit 81 is then finished.

Compared to the conventional assembling configurations for the corrugated pipe applying the connecting nozzle 82 and the connecting sleeve 83 and being cumbersome in assembling and disassembling, in the corrugated pipe mounting assembly of the present invention, the connector 20 has the pivot configuration of the operating element 22 and the connecting mount 21 with the two engaging components 23 respectively disposed on the operating element 22 and the connecting mount 21; each one of the multiple engaging stripes 231 is inserted into the corresponding gap 12 of the corrugated pipe 10 when mounting. Therefore, the corrugated pipe 10 can be stably mounted via the connector 20 only; otherwise, when assembling or disassembling, a user only needs to actuate the operating element 22 to pivot and connect the operating end of the operating element 22 and the connecting mount 21 or vice versa. The present invention thus provides the corrugated pipe mounting assembly that makes operations of assembling and disassembling easier and has sufficient mounting stability.

With reference to FIGS. 2 and 3, specifically, in the preferred embodiment, the connecting mount 21 has a fastening hole 211 disposed thereon, and the operating element 22 has a fastening head 221 disposed on the operating end. The fastening head 221 is configured to be fastened to the fastening hole 211 as the operating element 22 pivots relative to the connecting mount 21 to fix the operating element 22 with respect to the connecting mount 21, but the present invention is not limited to the preferred embodiment; in other embodiments, the connecting mount 21 may have the fastening head 221 disposed thereon with the fastening hole 211 on the operating element 22, or the operating end of the operating element 22 can be fixed to the connecting mount 21 via a plug, pin, bolt, or other fixing methods. In the preferred embodiment, the fastening hole and the fastening head 221 allow the operating end of the operating element 22 to be quickly fixed to the connecting mount 21 as the operating element 22 pivots relative to the connecting mount 21, which further improves convenience of operation.

With reference to FIGS. 2 to 4, in the preferred embodiment, the connecting mount 21 has an engaging edge 212 disposed thereon, and the operating element 22 has an engaging groove 222 disposed thereon. The engaging edge 212 is configured to be engaged into the engaging groove 222 as the operating element 22 pivots relative to the connecting mount 21, which limits the movement of the operating element 22 relative to the connecting mount 21 except for the relative pivot and further improves the stability of the operating end of the operating element 22 connected to the connecting mount 21. The present invention is not limited to the preferred embodiment; in other embodiments, the connecting mount 21 may have the engaging groove 222 disposed thereon with the engaging edge 212 on the operating element 22, or the connector may omit the configuration of the engaging edge 212 and the engaging groove 222.

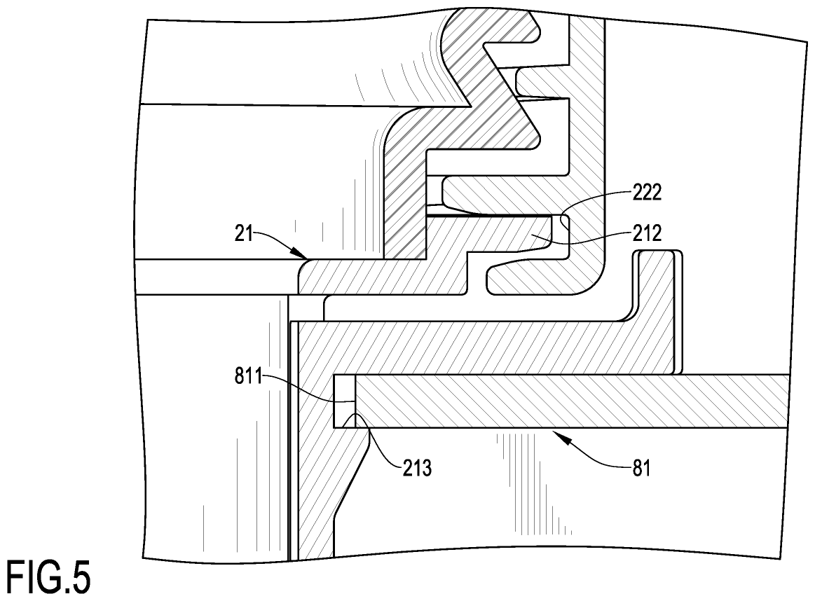

With reference to FIGS. 4 and 5, in the preferred embodiment, the connecting mount 21 has two engaging recesses 213, and the two engaging recesses 213 are located at two opposite positions on the connecting mount 21 and face each other. During mounting, the two engaging recesses 213 are configured for a surrounding edge of the opening 811 of the window kit 81 to be engaged with, which allows the connecting mount 21 to be mounted to the opening 811 of the window kit 81 such that the corrugated pipe 10 fluidly communicates with the outdoors. The movable air conditioner 70 discharges waste heat to the outdoors via the corrugated pipe 10 and the opening 811 of the window kit 81. In other embodiments, the connecting mount 21 may be formed in one piece with the window kit 81. The preferred embodiment adopts the engaging configuration between the connecting mount 21 and the window kit 81 such that the connecting mount 21 can be detached from the window kit 81 and be replaced with another connecting mount 21 having a different size for mounting another corrugated pipe 10 having a different diameter.

With reference to FIGS. 1 and 6, in the preferred embodiment, the assembly adaptor 30 allows the inlet end of the corrugated pipe 10 to be mounted onto the movable air conditioner 70. The assembly adaptor 30 has a main body 31 being elastic and two stripe components 32 disposed on the main body 31, and two opposite ends of the main body 31 can be connected to each other. Specifically, the main body 31 has an arc-shaped construction, and the two opposite ends of the main body 31 can approach each other to make the main body 31 closed to be annular in shape or move away from each other to slightly unfold the main body 31 via the elasticity of the main body 31. Each one of the two stripe components 32 has multiple stripes 321 protruding from the main body 31, arranged at spaced intervals, and extending along a same direction. Said stripe components 32 basically work in the same way as said engaging components 23 of the connector 20. When the main body 31 is closed to be annular in shape, the two stripe components 32 face each other.

During assembly, the main body 31 is first slightly unfolded to surround the corresponding one of the two opposite ends of the corrugated pipe 10, and then the two opposite ends of the main body 31 approach each other and are attached to each other, which makes the main body 31 sheathed onto the inlet end of the corrugated pipe 10 and makes each one of the multiple stripes 321 inserted into a respective one of the multiple gaps 12 of the corrugated pipe 10. Next, the assembly adaptor 30 and the inlet end of the corrugated pipe 10 are placed in a mounting groove 71 disposed on an outlet of the movable air conditioner 70; afterwards, the two opposite ends of the main body 31 are connected to each other and fixed to a groove wall of the mounting groove 71. Assembling of the corrugated pipe 10 to the movable air conditioner 70 is then finished.

Specifically, in the preferred embodiment, the assembly adaptor 30 has two lugs 311 respectively extending from the two opposite ends of the main body 31, and each one of the two lugs 311 has a connecting hole defined therethrough. Said connecting holes of the two lugs 311 are configured to be aligned with each other for a bolt to be mounted through so as to fix the two lugs 311 and connect the two opposite ends of the main body 31 to the mounting groove 71. Otherwise, the movable air conditioner 70 has a limiting notch 72 formed on an edge of a groove opening of the mounting groove 71; when the assembly adaptor 30 is placed in the mounting groove 71, the two lugs 311 are limited inside the limiting notch 72, which prevents the main body 31 from rotating or being unfolded due to its elasticity and thus improves convenience of operation.

With reference to FIG. 6, in the preferred embodiment, the main body 31 has a fastening groove 312 recessed on a peripheral surface of the main body 31, and the mounting groove 71 has a fastening unit 711 disposed on the groove wall of the mounting groove 71 and configured to be bent elastically. When the assembly adaptor 30 starts to be placed in the mounting groove 71, a peripheral surface of the main body 31 first pushes away the fastening unit 711. After the assembly adaptor 30 is completely placed in the mounting groove 71, the fastening unit 711 rebounds and is fastened into the fastening groove 312. With the fastening groove 312 disposed on the main body 31 for fastening the fastening unit 711, the stability of mounting the corrugated pipe 10 via the assembly adaptor 30 can be further improved.

In the preferred embodiment, the inlet end of the corrugated pipe 10 is mounted to the movable air conditioner 70 via the assembly adaptor 30, but the present invention is not limited to the preferred embodiment. In other embodiments, the inlet end of the corrugated pipe 10 can be directly connected to the movable air conditioner 70 by gluing, welding or other fixing methods. In the preferred embodiment, the assembly adaptor 30 allows the corrugated pipe 10 to be detached from the movable air conditioner 70 such that the corrugated pipe 10 can be cleaned and replaced conveniently.

In the preferred embodiment, the corrugated pipe mounting assembly is applied for connecting the movable air conditioner 70 to the window kit 81 for the movable air conditioner 70 to fluidly communicate with the outdoors. In other embodiments, the corrugated pipe mounting assembly may be applied to mount the corrugated pipe 10 for conveying other fluids (e.g., gas or water). As long as the connector 20 has the connecting mount 21, the pivotable operating element 22, and the two engaging components 23, the corrugated pipe mounting assembly achieves the effect of simplifying assembling and disassembling and maintaining sufficient mounting stability. The application of the present invention is not limited to the description in the preferred embodiment.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A corrugated pipe assembly comprising:
a corrugated pipe having
multiple protruding stripes located on a periphery of the corrugated pipe and arranged at spaced intervals; and
multiple gaps, and each one of the multiple gaps formed between adjacent two of the multiple protruding stripes; and
a connector having
a connecting mount;
an operating element having
a pivot end pivotally connected to the connecting mount; and
an operating end being opposite to the pivot end; and
two engaging components respectively disposed on the connecting mount and the operating element, and each one of the two engaging components having
multiple engaging stripes protruding from the connecting mount or the operating element and arranged at spaced intervals;
wherein the operating element is configured to pivot relative to the connecting mount such that the operating end is connected to the connecting mount, the operating element and the connecting mount are sheathed onto one of two opposite ends of the corrugated pipe, and each one of the multiple engaging stripes is inserted into a respective one of the multiple gaps of the corrugated pipe.

2. The corrugated pipe mounting assembly as claimed in claim 1, wherein
the connector has a fastening head and a fastening hole;
the fastening head and the fastening hole are respectively disposed on the connecting mount and the operating end of the operating element; and
the fastening head is configured to be fastened to the fastening hole as the operating element pivots relative to the connecting mount to fix the operating element with respect to the connecting mount.

3. The corrugated pipe mounting assembly as claimed in claim 2, wherein
the connector has an engaging edge and an engaging groove;
the engaging edge and the engaging groove are respectively disposed on the connecting mount and the operating element; and
the engaging edge is configured to be engaged into the engaging groove as the operating element pivots relative to the connecting mount.

4. The corrugated pipe mounting assembly as claimed in claim 1, wherein
the connector has an engaging edge and an engaging groove;
the engaging edge and the engaging groove are respectively disposed on the connecting mount and the operating element; and
the engaging edge is configured to be engaged into the engaging groove as the operating element pivots relative to the connecting mount.

5. The corrugated pipe mounting assembly as claimed in claim 1, wherein
the corrugated pipe mounting assembly has an assembly adaptor;
the connector and the assembly adaptor are configured to be respectively connected to the two opposite ends of the corrugated pipe;
the assembly adaptor has
a main body being elastic and having two opposite ends; and
at least one stripe component having
multiple stripes protruding from the main body and arranged at spaced intervals; and
the two opposite ends of the main body are configured to be connected to each other such that the main body is sheathed onto the corresponding end of the corrugated pipe and each one of the multiple stripes is inserted into a respective one of the multiple gaps of the corrugated pipe.

6. The corrugated pipe mounting assembly as claimed in claim 2, wherein
the corrugated pipe mounting assembly has an assembly adaptor;
the connector and the assembly adaptor are configured to be respectively connected to the two opposite ends of the corrugated pipe;
the assembly adaptor has
a main body being elastic and having two opposite ends; and
at least one stripe component having
multiple stripes protruding from the main body and arranged at spaced intervals; and
the two opposite ends of the main body are configured to be connected to each other such that the main body is sheathed onto the corresponding end of the corrugated pipe and each one of the multiple stripes is inserted into a respective one of the multiple gaps of the corrugated pipe.

7. The corrugated pipe mounting assembly as claimed in claim 3, wherein
the corrugated pipe mounting assembly has an assembly adaptor;
the connector and the assembly adaptor are configured to be respectively connected to the two opposite ends of the corrugated pipe;
the assembly adaptor has
a main body being elastic and having two opposite ends; and
at least one stripe component having
multiple stripes protruding from the main body and arranged at spaced intervals; and
the two opposite ends of the main body are configured to be connected to each other such that the main body is sheathed onto the corresponding end of the corrugated pipe and each one of the multiple stripes is inserted into a respective one of the multiple gaps of the corrugated pipe.

8. The corrugated pipe mounting assembly as claimed in claim 4, wherein
the corrugated pipe mounting assembly has an assembly adaptor;
the connector and the assembly adaptor are configured to be respectively connected to the two opposite ends of the corrugated pipe;
the assembly adaptor has
a main body being elastic and having two opposite ends; and
at least one stripe component having
multiple stripes protruding from the main body and arranged at spaced intervals; and
the two opposite ends of the main body are configured to be connected to each other such that the main body is sheathed onto the corresponding end of the corrugated pipe and each one of the multiple stripes is inserted into a respective one of the multiple gaps of the corrugated pipe.

9. The corrugated pipe mounting assembly as claimed in claim 5, wherein
the assembly adaptor has two lugs respectively extending from the two opposite ends of the main body;
each one of the two lugs has a connecting hole defined therethrough; and
said connecting holes of the two lugs are configured to be aligned with each other for a bolt to be mounted through such that the two lugs are fixed with each other and connect the two opposite ends of the main body.

10. The corrugated pipe mounting assembly as claimed in claim 6, wherein
the assembly adaptor has two lugs respectively extending from the two opposite ends of the main body;
each one of the two lugs has a connecting hole defined therethrough; and
said connecting holes of the two lugs are configured to be aligned with each other for a bolt to be mounted through such that the two lugs are fixed with each other and connect the two opposite ends of the main body.

11. The corrugated pipe mounting assembly as claimed in claim 7, wherein
the assembly adaptor has two lugs respectively extending from the two opposite ends of the main body;
each one of the two lugs has a connecting hole defined therethrough; and
said connecting holes of the two lugs are configured to be aligned with each other for a bolt to be mounted through such that the two lugs are fixed with each other and connect the two opposite ends of the main body.

12. The corrugated pipe mounting assembly as claimed in claim 8, wherein
the assembly adaptor has two lugs respectively extending from the two opposite ends of the main body;
each one of the two lugs has a connecting hole defined therethrough; and
said connecting holes of the two lugs are configured to be aligned with each other for a bolt to be mounted through such that the two lugs are fixed with each other and connect the two opposite ends of the main body.

13. The corrugated pipe mounting assembly as claimed in claim 5, wherein the main body of the assembly adaptor has a fastening groove recessed on a peripheral surface of the main body and configured for a fastening unit to be fastened to.

14. The corrugated pipe mounting assembly as claimed in claim 6, wherein the main body of the assembly adaptor has a fastening groove recessed on a peripheral surface of the main body and configured for a fastening unit to be fastened to.

15. The corrugated pipe mounting assembly as claimed in claim 7, wherein the main body of the assembly adaptor has a fastening groove recessed on a peripheral surface of the main body and configured for a fastening unit to be fastened to.

16. The corrugated pipe mounting assembly as claimed in claim 8, wherein the main body of the assembly adaptor has a fastening groove recessed on a peripheral surface of the main body and configured for a fastening unit to be fastened to.

17. The corrugated pipe mounting assembly as claimed in claim 1, wherein
the connecting mount of the connector has two engaging recesses; and
the two engaging recesses are configured for engaging a surrounding edge of an opening defined through a window kit to mount the connecting mount to the window kit.

18. The corrugated pipe mounting assembly as claimed in claim 2, wherein
the connecting mount of the connector has two engaging recesses; and
the two engaging recesses are configured for engaging a surrounding edge of an opening defined through a window kit to mount the connecting mount to the window kit.

19. The corrugated pipe mounting assembly as claimed in claim 3, wherein
the connecting mount of the connector has two engaging recesses; and
the two engaging recesses are configured for engaging a surrounding edge of an opening defined through a window kit to mount the connecting mount to the window kit.

20. The corrugated pipe mounting assembly as claimed in claim 4, wherein
the connecting mount of the connector has two engaging recesses; and
the two engaging recesses are configured for engaging a surrounding edge of an opening defined through a window kit to mount the connecting mount to the window kit.
